(19) United States
(12) Patent Application Publication
(10) Pub. No.: US 2013/0191484 A1
(43) Pub. Date: Jul. 25, 2013

(54) MAIL TRANSFER SYSTEM, MAIL GATEWAY AND DATA STORE SERVER

(71) Applicant: Masafumi Kinoshita, Sagamihara (JP)

(72) Inventor: Masafumi Kinoshita, Sagamihara (JP)

(73) Assignee: HITACHI, LTD., Tokyo (JP)

(21) Appl. No.: 13/806,330

(22) PCT Filed: Jun. 16, 2011
(86) PCT No.: PCT/JP2011/063828

§ 371 Date: Mar. 11, 2013

(30) Foreign Application Priority Data
Aug. 31, 2010 (JP) 2010-193122

(51) Int. Cl. H04L 12/58

(52) U.S. Cl. CPC H04L 51/04
USPC 709/206

(57) ABSTRACT

It is provided a mail transfer system including a mail gateway, a network and a data storage area. The mail gateway, in a case where destinations of the received electronic mail include a plurality of destinations accommodated in the same mail transfer server, generate a piece of first mail management information including the plurality of destinations, and store mail data linking the generated piece of first mail management information and a body of the electronic mail to each other in the data storage area. The mail gateway, in a case where the destinations of the received electronic mail include one destination accommodated in the same mail transfer server, generate mail management information, which includes the each of the destinations, and store mail data linking each of a plurality of pieces of the generated mail management information and a body of the electronic mail in the data storage area.

### CROSS-REFERENCE TO RELATED APPLICATIONS

The present application claims priority from Japanese patent application JP 2010-193122 filed on Aug. 31, 2010, the content of which is hereby incorporated by reference into this application.

### BACKGROUND

This invention relates to a mail transfer system, and more particularly, to a mail transfer system for reducing a storage capacity for storing a mail transmitted to a plurality of destinations, and increasing efficiency of transfer of the mail.

Mail relay devices (such as a mail gateway and a mail transfer agent) for transferring an electronic mail to a destination node temporarily store received mails in a storage device (such as a magnetic disk drive), and transfer the stored mails to specified destinations. In the mail relay devices, a performance of reading/writing data from/to the storage device constitutes a bottleneck.

Moreover, there is proposed a method involving generating, when the mail relay device receives a mail including a plurality of destinations, and transmits the same electronic mail to the plurality of destinations, copies of the mail as many as the destinations of the mail, and storing the copied plurality of mails in the storage device. In this case, the number of the copied mails consumes the capacity of the storage device and increases the number of times of reading/writing on the storage device, which constitutes a bottleneck in the performance. Therefore, reducing the data amount required for storing the electronic mails, and realizing efficient transfer of the electronic mails have been required.

The reduction in the capacity of the storage device for storing the mails, and the increase in the efficiency of the management and transfer of the mails are in a trade-off relationship, and the reduction in the capacity and the increase in the efficiency need to be realized simultaneously.

In view of the above-mentioned requirement, for example, a mail system described in JP H7-264234 is proposed. The mail system described in JP H7-264234 provides a mail information storage module for separating a body of a mail and transmission information on the mail from each other and registering the transmission information, and a mail management module for managing data in the mail information storage module, thereby delivering the mail not to respective destinations, but to a storage area of the mail. Therefore, when the same electronic mail is transmitted to a plurality of destinations, a data amount required for storing the electronic mail is reduced.

For example, a mail relay device operated by a cellular phone carrier provides different types of processing depending on a type of a mail. Specifically, in order to control congestion of mails for each of domains, a transmission queue is generally provided for each of mail relay devices of transmission destinations (for each of the domains).

However, the above-mentioned conventional method does not consider the application to the mail relay device provided with the plurality of transmission queues. In other words, it is necessary to carry out access control and transcoding depending on a domain contained in a destination address.

Moreover, even in the same queue, depending on the destination, both successes and failures of the transfer of a mail may exist. The conventional method does not consider the coexistence of the successes and failures of the transfer of a mail for a plurality of destinations.

### SUMMARY OF THE INVENTION

This invention therefore has an object to reduce a storage capacity required for storing mails and increase efficiency of relay processing for the mails.

The representative one of inventions disclosed in this application is outlined as follows. There is provided a mail transfer system including a mail gateway for receiving an electronic mail transmitted from a terminal, a network for coupling the terminal and the mail gateway to each other, and a data storage area for temporarily storing the received electronic mail. The mail gateway is coupled to a plurality of mail transfer servers. The mail gateway includes a queue for storing a mail to be transferred for each of the plurality of mail transfer servers being transfer destinations of the mail. The mail gateway, in a case where destinations of the received electronic mail include a plurality of destinations accommodated in the same mail transfer server, generate a piece of first mail management information including the plurality of destinations accommodated in the same mail transfer server, and store mail data linking the generated piece of first mail management information and a body of the electronic mail to each other in the data storage area. The mail gateway, in a case where the destinations of the received electronic mail include one destination accommodated in the same mail transfer server, generate mail management information for each of the destinations, which includes the each of the destinations, and store mail data linking each of a plurality of pieces of the generated mail management information and a body of the electronic mail in the data storage area.

According to the disclosure, the storage capacity required for storing mails can be reduced, and the efficiency of the relay processing for the mails can be increased.

### BRIEF DESCRIPTION OF THE DRAWINGS

FIG. 1 is a block diagram illustrating a configuration of a mail transfer system according to a first embodiment.

FIG. 2 is a block diagram illustrating a configuration of a mail gateway according to the first embodiment.

FIG. 3A is diagram illustrating mail management methods used in the first embodiment.

FIG. 3B is diagram illustrating mail management methods used in the first embodiment.

FIG. 3C is diagram illustrating mail management methods used in the first embodiment.

FIG. 4 illustrates an example (a case where mail data is shared) of a sequence of mail transfer processing according to the first embodiment.

FIG. 5 is a flowchart for a RCPT check processing according to the first embodiment.

FIG. 6 is a flowchart of management method determination processing (mail body check processing) according to the first embodiment.

FIG. 7 is a sequence diagram in a case where delivery to a part of destinations of a mail for which data on a mail body is managed in common fails according to the first embodiment.

FIG. 8 is a flowchart for mail transmission/deletion processing according to the first embodiment.

FIG. 9 is a block diagram illustrating a configuration of a mail transfer system according to a second embodiment.

FIG. 10 is a block diagram illustrating a configuration of a mail gateway according to the second embodiment.

FIG. 11 is a block diagram illustrating a configuration of a data store server according to the second embodiment.

FIG. 12 illustrates an example (a case where mail data is shared) of a sequence of mail transfer processing according to the second embodiment.

FIG. 13 is a diagram illustrating an example of a packet transmitted to the data store server according to the second embodiment.

FIG. 14 is a diagram illustrating mail management performed by the mail gateway according to the second embodiment.

FIG. 15 is a flowchart of packet configuration processing performed by the mail gateway according to the second embodiment.

FIG. 16 is a diagram illustrating storage of data in the data store server according to the second embodiment.

FIG. 17 is a flowchart of packet storing processing performed by the data store server according to the second embodiment.

### DETAILED DESCRIPTION OF THE EMBODIMENTS

### First Embodiment

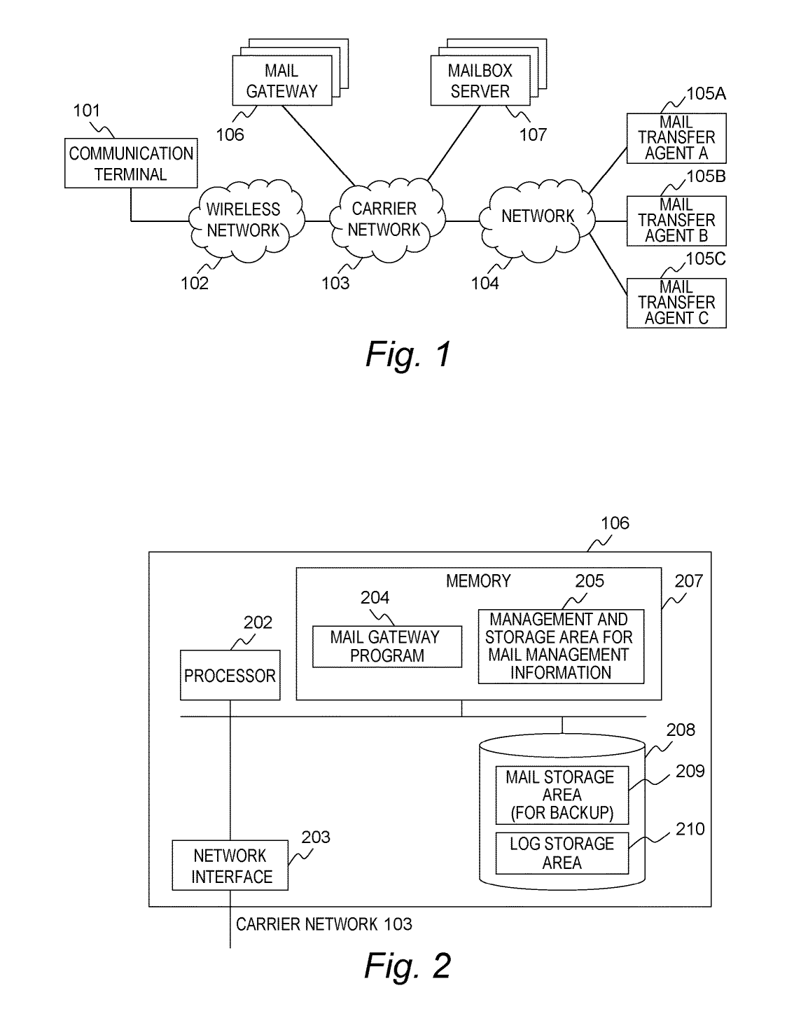

FIG. 1 is a block diagram illustrating a configuration of a mail transfer system according to a first embodiment of this invention.

The mail transfer system according to this embodiment is constituted in a carrier network 103, and includes a mail gateway 106, and a mailbox server 107. The mail gateway 106 and the mailbox server 107 are connected to each other by the carrier network 103.

The carrier network 103 is connected via a wireless network 102 to a communication terminal 101, and is connected via a network 104 to a plurality of mail transfer agents 105A to 105C.

The mail gateway 106 is a computer for receiving data on an electronic mail transmitted from the communication terminal 101, and transferring the received mail data to the mail transfer agent 105A or the like. Moreover, the mail gateway 106 has a function of transmitting, in addition to electronic mails, messages such as charge information to each of destinations of a mail, a notification to a cellular phone that a mail has been received, a delivery notification notifying a sender of a mail that the mail has normally delivered to a destination, and the like. Those messages are realized by the same mechanism in terms of transmitting a message to a destination as that for the transmission of the electronic mail. According to this embodiment, though a description is not given of those messages, this invention may be applied to the transfer of those messages. A description is given later of a configuration of the mail gateway 106 referring to FIG. 2.

The mailbox server 107 is a computer for storing data on mails received by the mail gateway 106, and to be sent to the communication terminal 101 accommodated in the own network, and is a so-called POP server or IMAP server.

The wireless network 102 includes a base station and a switch, and is connected via a wireless communication line to the communication terminal 101. The communication terminal 101 is a mobile communication terminal such as a cellular phone, and has a function of transmitting/receiving a mail such as an MMS and an Internet mail.

The mail transfer agents 105A to 105C are computers serving as transfer destinations of mail data received by the mail gateway 106. The mail transfer agents 105A to 105C may be mail servers for accommodating destination addresses or mail transfer agents on transfer paths to mail servers for accommodating the destination addresses.

The network 104 is a network, such as the Internet, for exchanging mail data among a plurality of mail transfer agents.

FIG. 2 is a block diagram illustrating a configuration of the mail gateway 106 according to the first embodiment.

The mail gateway 106 includes a processor 202, a memory 207, a network interface 203, and a non-volatile storage device 208.

The processor 202 executes a mail gateway program 204. By the processor 202 executing the mail gateway program 204, various pieces of processing carried out by the mail gateway 106 are realized.

The network interface 203 is connected to the carrier network 103, and carries out communication in accordance with a predetermined protocol. The storage device 208 is a non-volatile storage device such as a magnetic disk device or a flash memory, and is provided with a mail storage area 209 and a log storage area 210.

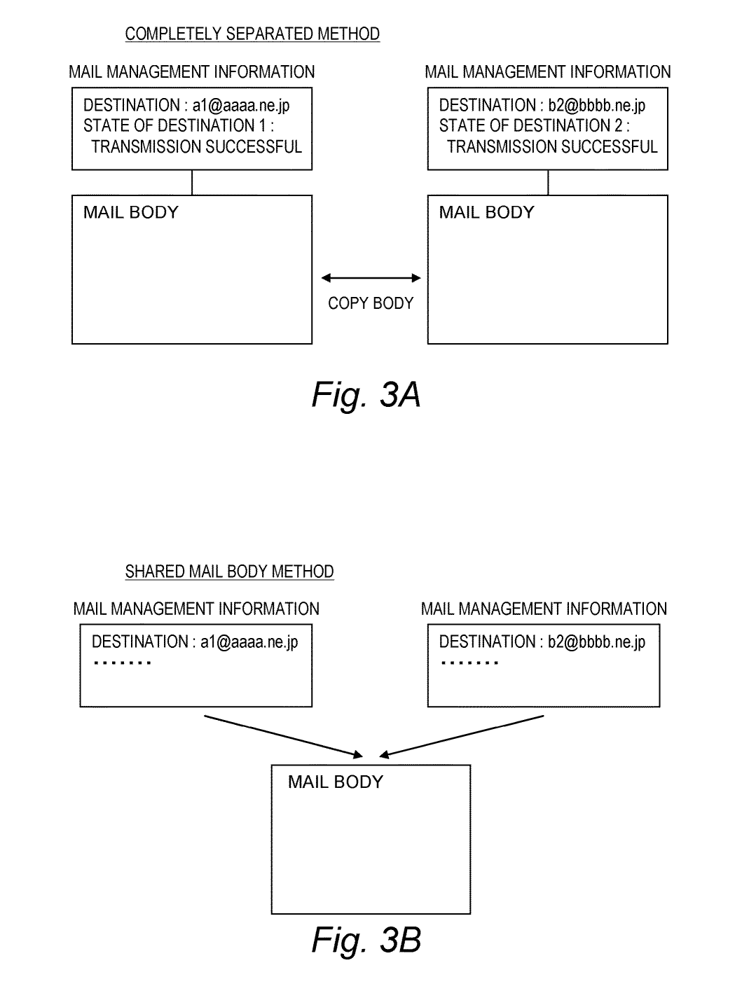

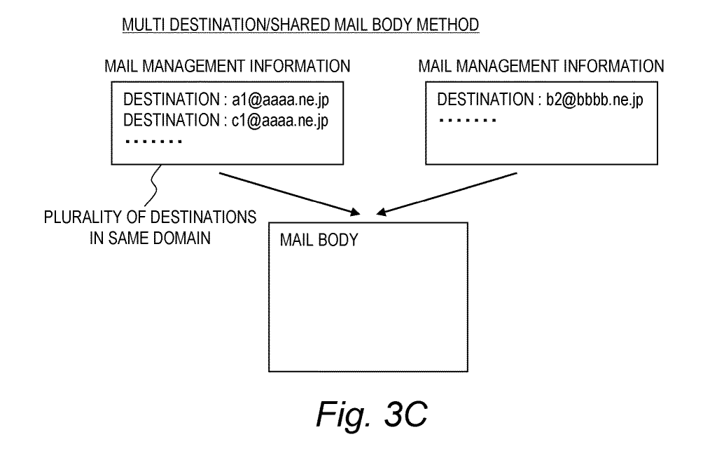

The mail gateway 106 includes transmission queues for respective domains of transfer destinations of mails (mail transfer agents), and stores received mails in the transmission queues. The mail stored in the transmission queue is transferred to the mail transfer agents 105A or the like which is a transfer destination. Moreover, the mail gateway 106 stores a received mail both in a management and storage area for mail management information 205 and the mail storage area 209 for backup. The management and storage area for mail management information 205 is on the memory 207, and is high in read/write speed compared with the storage device 208, and, generally, the mail gateway 106 reads/writes mail management information (detailed referring to FIG. 3) on the management and storage area for mail management information 205, and carries out various processing. When the mail gateway 106 stops, data on the memory 207 is lost, and even when the mail gateway 106 stops due to a failure or the like, in order to prevent received mail from being lost, the received mails are also stored in the mail storage area 209 for backup. The mails stored in the management and storage area for mail management information 205 and the mail storage area 209 are deleted after the mails have been transferred to transfer destination servers. The mail gateway 106 usually makes an access only twice to the mail storage area 209 for backup when a mail is received and stored, and when the mail has been transferred and is deleted.

FIGS. 3A to 3C are diagrams illustrating mail management methods used in the first embodiment.

Data on a mail received by the mail gateway 106 is stored as a mail body of the figures. The mail management information is data generated by the mail gateway 106 by analyzing communication of the mail client and the mail body in order to perform mail transfer processing, is information transferred when the mail is transferred between mail relay devices, and includes a destination, a sender, authentication information, a usage of the mail, and a type of the mail. The mail gateway 106 processes the transfer of a mail by using the mail management information.

As illustrated in FIG. 3A, a completely separated method, which is a first method, involves generating, by copying a body of a mail, as many mail bodies as the number of destinations of the mail, and generating mail data (mail management information and mail body) for each of the mail destinations. As described later, if a mail body needs to be rewritten for each of destinations before transfer, the completely separated method is applied, but the completely separated method may also be applied to a case where a mail body is the same for a plurality of destinations. In the completely separated method, mail data including a mail body is generated for each of destinations, and a large storage area is necessary for storing the mail data, but the method has advantages of easy management of a state (such as completed transfer state and non-delivery state) of a mail for each of destinations and easy recovery processing for mails when a failure occurs.

As illustrated in FIG. 3B, a shared mail body method, which is a second method, involves generating a plurality of pieces of mail management information for respective destinations, but a mail body is common to each of the pieces of mail management information. Each of the pieces of mail management information is linked to the mail body, and the correspondence thereof is thus managed. In other words, in the shared mail body method, each piece of mail management information includes one destination, and the mail body is common to all pieces of mail management information (all destinations). The shared mail body method, as described later, is applied to a case where a plurality of destinations belong to different domains. Moreover, the shared mail body method is applied to a case where when a mail is transferred to a plurality of destinations in the own network, and a case where, for each of destination mailboxes, mail data is divided. In this case, the data stored in the mail storage area includes mail management information for each of the destination mailboxes, and one mail body.

In the shared mail body method, the mail body is shared by a plurality of pieces of mail management information, and hence the storage area required for storing the mail data can be reduced. However, in the shared mail body method, management of mail becomes complex by, for example, using a reference counter for managing a state of a mail for each of destinations, and recovery processing for mails at the time of an occurrence of a failure is thus complex.

As illustrated in FIG. 3C, a multi destination/shared mail body method, which is a third method, involves generating a plurality of pieces of mail management information, and a mail body is common to respective pieces of mail management information, but each of the pieces of mail management information includes one or a plurality of destinations. Each of the pieces of mail management information is linked to the mail body, and the correspondence thereof is thus managed. The multi destination/shared mail body method, as described later, is applied to a case where a mail is to be transferred to a plurality of destinations accommodated in the same mail transfer agents 105A or the like. However, the multi destination/shared mail body method cannot be applied to a case where there are a plurality of destinations in the own network. This is because, in the own network, mails are transferred from the mail gateway 106 to destination mailboxes, and states (such as transfer success state and non-delivery state) of the mails need to be managed for the respective mailboxes. Moreover, in the own network, a plurality of servers such as the mailbox server 107, a delivery notification transmission server, a DNS, and the like cooperate with one another for processing, and the state of the mails differ from one another depending on the destinations in the own network, and hence the multi destination/shared mail body method is not suitable.

In the multi destination/shared mail body method, mail data generated for each of destinations includes mail management information without a mail body, the mail body is shared among the respective pieces of mail management information, and further, the mail management information is made common to a plurality of destinations, and hence a storage area required for storing the mail data can thus be reduced. On the other hand, in the multi destination/shared mail body method, the numbers of destinations included in the mail management information are different, and hence the management of the state (such as transfer success state and non-delivery state) of the mail is thus complex. In this case, by outputting the transfer success state (or non-delivery state) to a log, or recording the state in the mail management information, processing can be separately applied depending on the state of the mail.

Further, the multi destination/shared mail body method cannot be applied to a case where respective mails are processed completely differently. The multi destination/shared mail body method cannot be applied to a case where processing is separately applied.

As described above, the mail gateway 106 is provided with a transmission queue for each of the transfer destination domains. Therefore, mails transmitted to different domains are different in state, and hence mail management information is preferably separated into a plurality of pieces of mail management information. Therefore, this embodiment uses the above-mentioned three mail management methods depending on cases.

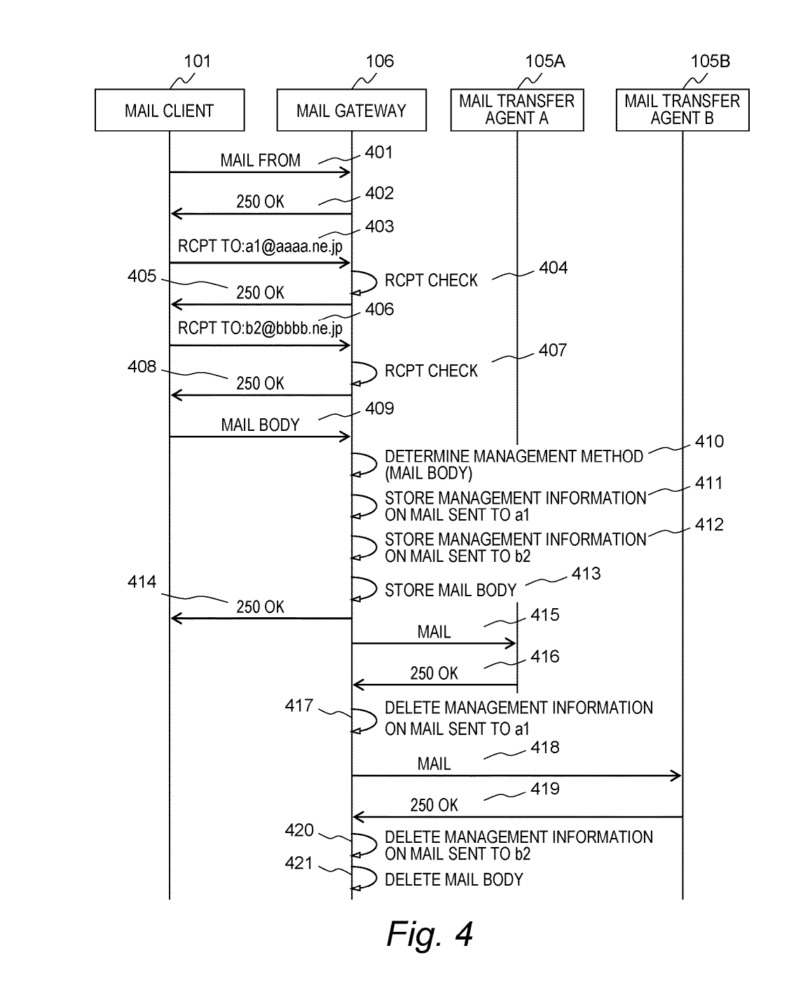

FIG. 4 illustrates an example (a case where mail data is shared) of a sequence of mail transfer processing according to the first embodiment.

It should be noted that, though the mail transfer agents 105A and 105B are mail servers for accommodating destination addresses, the mail transfer agents 105A and 105B may be mail transfer agents on transfer paths to mail servers for accommodating the destination addresses.

When the communication terminal (mail client) 101 transmits a mail, the communication terminal 101 establishes a connection to the mail gateway, and then transmits to the mail gateway 106 a MAIL FROM message 401, thereby notifying of an address of the transmission source of the mail. In a parameter of the MAIL FROM message 401, the address of the transmission source of the mail is described. When the mail gateway 106 normally receives the MAIL FROM message, the mail gateway 106 transmits, to the mail client 101, a 250 OK message 402 indicating that the MAIL FROM message is normally received.

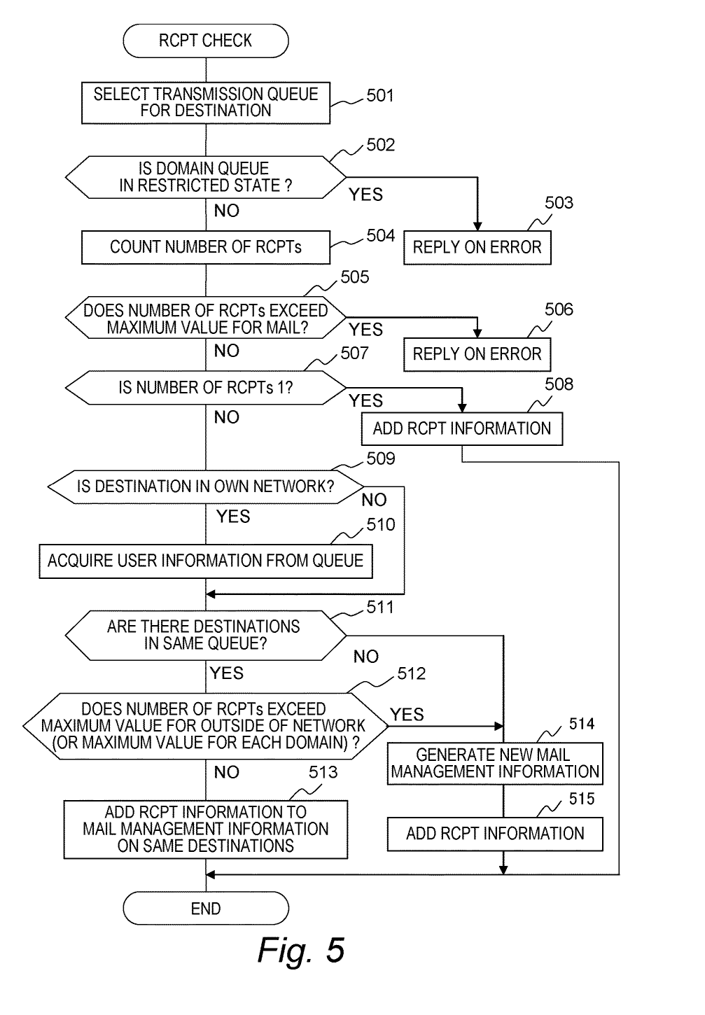

Then, the mail client 101 transmits a RCPT TO message 403 to the mail gateway 106, thereby notifying of one destination address (a1@aaaa.ne.jp) of the mail. In a parameter of the RCPT TO message, the destination address is described. The mail gateway 106 determines whether or not the destination address included in the received RCPT TO message is correct, and primarily determines a method of storing the mail in the management and storage area for mail management information 205 and the mail storage area 209 (404). Then, when the mail gateway 106 determines that the destination address is correct, the mail gateway 106 transmits a 250 OK message 405 to the mail client 101. The RCPT check in Step 404 is detailed later referring to FIG. 5.

Then, when the mail includes a plurality of destinations, the mail client 101 transmits a RCPT TO message 406 to the mail gateway 106, thereby notifying of another destination address (b2@bbbb.ne.jp) of the mail. The mail gateway 106 determines whether or not the destination address included in the received RCPT TO message is correct, and primarily determines a method of storing the mail in the management and storage area for mail management information 205 and the mail storage area 209 (407). Then, when the mail gateway 106 determines that the destination address is correct, the mail gateway 106 transmits a 250 OK message 408 to the mail client 101. The RCPT check in Step 404 is detailed later referring to FIG. 5.

When the mail client 101 has transmitted all RCPT TO messages (destination addresses), the mail client 101 transmits a mail body 409. When the mail gateway 106 normally receives the mail (the transmission source, the management information such as the destinations, and the mail body), the mail gateway 106 determines the management method for the mail body (410), and, based on the determined method, stores the mail management information to be sent to a1, the mail management information to be sent to b2, and the mail body in the management and storage area for mail management information 205 and the mail storage area 209 (411, 412, and 413). Then, the mail gateway 106 transmits, to the mail client 101, a 250 OK message 414 indicating that the mail is normally received.

Then, the mail gateway 106 transfers the mail to the mail transfer agent A (105A) accommodating the destinational (415). When the mail transfer agent A (105A) normally receives the mail, the mail transfer agent A (105A) transmits, to the mail gateway 106, a 250 OK message 416 indicating that the mail is normally received. When the mail gateway 106 succeeds in the transfer of the mail addressed to the destinational, the mail gateway 106 deletes the management information on the mail addressed to the destination a 1 from the management and storage area for mail management information 205 and the mail storage area 209 (417). Moreover, the mail gateway 106 transfers the mail to the mail transfer agent B (105B) accommodating the destination b2 (418). When the mail transfer agent B (105B) normally receives the mail, the mail transfer agent B (105B) transmits, to the mail gateway 106, a 250 OK message 419 indicating that the mail is normally received. Then, when the mail gateway 106 succeeds in the transfer of the mail addressed to the destination b2, the mail gateway 106 deletes the management information on the mail addressed to the destination b2 from the management and storage area for mail management information 205 and the mail storage area 209 (420).

Further, when the mail gateway 106 has transmitted the mails to all the destinations, the mail gateway 106 deletes the mail data from the management and storage area for mail management information 205 and the mail storage area 209 (421).

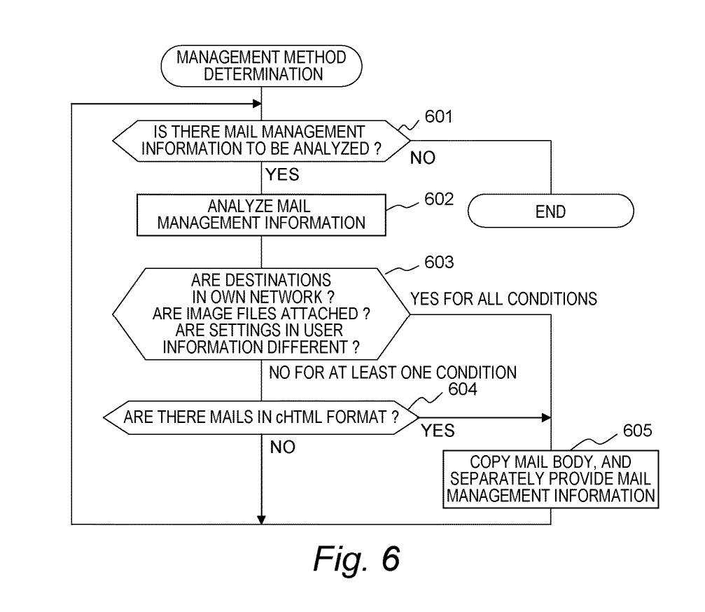

It should be noted that, depending on the result of the determination in Step 410, the above-mentioned sequence differs more or less. For example, in Step 410, when it is determined that the mail is processed in the completely separated method (Step 605 of FIG. 6), in Step 417, the management information and the mail body of the mail addressed to the destinational may be deleted, and in Step 420, the management information and the mail body of the mail addressed to the destination b2 may be deleted. In the completely separated method, the mail management information and the mail body correspond to each other in a one-to-one manner, and, in this configuration, the mail body may not be deleted in Step 421.

Moreover, in Step 410, when it is determined to process the mail in the multi destination/shared mail body method (Step 513 of FIG. 5. In this case, there are two destinations in a domain A.com.), in Step 415, two mails may be transmitted (two RCPT TOs may be successively transmitted), in Step 417, the management information (storing two destinations) on the mail addressed to the destinational may be deleted, in Step 420, the management information on the mail addressed to the destination b2 may be deleted, and in Step 421, the common mail body may be deleted.

FIG. 5 is a flowchart for the RCPT check processing according to the first embodiment, and is carried out in Steps 404 and 407 of FIG. 4 by the mail gateway 106 (mail gateway program 204). The RCPT check processing analyzes a header (particularly, destination address) of a mail, thereby determining the management method for the mail.

First, the mail gateway 106 refers to the destination mail address, thereby selecting a transmission queue corresponding to a domain to which the destination belongs (501).

Then, the mail gateway 106 determines whether or not the transmission queue selected in Step 501 is in a restricted state (502). As a result, when the selected transmission queue is in the restricted state, the mail cannot be sent to the destination, and hence the mail gateway 106 transmits an error message to the mail client 101 (503). On the other hand, when the selected transmission queue is not in the restricted state, the mail gateway 106 proceeds to Step 504.

In Step 504, the mail gateway 106 counts the number of destinations (number of RCPTs) of the mail (504), and determines whether or not the counted number of RCPTs exceeds a maximum value permitted in a single mail (505). As a result, when the counted number of RCPTs exceeds the maximum value for the mail, the mail cannot be transferred to the destinations, and hence the mail gateway 106 replies an error to the mail client 101 (506). On the other hand, when the counted number of RCPTs does not reach the maximum value for the mail, the mail gateway 106 proceeds to Step 507.

In Step 507, the mail gateway 106 determines whether or not the counted number of RCPTs is “1”. As a result, when the counted number of RCPTs is “1”, the mail only needs to be transferred to a single destination, and the mail gateway 106 generates mail management information describing RCPT information on the destination, and finishes the RCPT check processing (508). On the other hand, when the counted number of RCPTs is not “1”, this mail needs to be transferred to a plurality of destinations, and the mail gateway 106 proceeds to Step 509.

In Step 509, the mail gateway 106 determines whether or not the destination mail address is included in the own network. As a result, when the destination mail address is not included in the own network, the mail gateway 106 proceeds to Step 511. On the other hand, the destination mail address is included in the own network, the mail gateway 106 acquires user information from the mailbox server 107 (510), and proceeds to Step 511. The user information includes information on an attachment (particularly, a format and a size of an image file) which a terminal of a user can receive, information on a mailbox of a transfer destination of the mail, and information on configuration of a server for carrying out processing for the mailbox.

In Step 511, the mail gateway 106 determines whether or not there is a destination in the same domain as that of the destination. As a result, when there is no destination in the same domain as that of the destination, there is no destination of a mail transferred to the same mail transfer agent 105A or the like as that of the destination, which means it is necessary to generate mail management information corresponding to this destination, and the mail gateway 106 proceeds to Step 514. On the other hand, when there is a destination in the same domain as that of the destination, the mail gateway 106 determines whether or not the number of RCPTs exceeds a maximum value for outside of network (512). The maximum value for the number of RCPTs is a maximum value for destinations of a single mail, namely a maximum value for destinations to which the mail can be transmitted at once by means of a single piece of mail management information. As a result, when the destination is outside the network and the number of the RCPTs exceeds the maximum value for outside of network, the mail gateway 106 proceeds to Step 514. On the other hand, when the number of RCPTs does not exceed the maximum value for outside of network, mail data grouped together in the form having a common mail body can be generated. For this purpose, the mail gateway 106 adds the RCPT information on the destination to the mail management information on the destinations in the same domain (513). In Step 512, the mail gateway 106 may not only include one maximum value for outside of network for the entire system, but also set individual maximum values for outside of network for respective destination domains. For example, when the destination is a domain such as a communication carrier that is very low in probability of transmission failure, the mail gateway 106 selects a large maximum value for outside of network. On the other hand, when the destination is a domain that is high in probability of transmission failure, the probability of failure is high, and hence the mail gateway 106 may set a small maximum value for outside of network, or may proceed to Step 514 without grouping destinations together in the same domain.

When there is no destination in the same domain as that of the destination or when the number of RCPTs exceeds the maximum value for outside of network (or maximum value for each domain), the mail to the destination is stored in a different queue, and hence different mail management information needs to be generated. Therefore, in Step 514, the mail gateway 106 generates new mail management information (514) and adds the RCPT information on the destination to the generated mail management information (515). When the number of RCPTs exceeds the maximum value in Step 512 and the new mail management information is generated in Step 514, the new mail management information can be used to group subsequent mails together until the number of RCPTs exceeds the maximum value.

FIG. 6 is a flowchart of the management method determination processing (mail body check processing) according to the first embodiment, and is carried out in Step 410 of FIG. 4 by the mail gateway 106 (mail gateway program 204). The mail body check processing analyzes the mail body, thereby determining the management method for the mail. In other words, by analyzing the mail body, for the mail for which the determination that the mail body is managed in a shared manner has already been made by the RCPT check processing (FIG. 5), the management method is changed to a form in which the mail bodies are separately provided.

First, the mail gateway 106 refers to mail management information, thereby determining whether or not there is mail management information to be analyzed (601). As a result, when there is no subject mail management information, the mail body check processing is finished. On the other hand, when there is subject mail management information, the mail gateway 106 proceeds to Step 602.

In Step 602, the mail gateway 106 analyzes the mail management information on the destination. Specifically, the mail gateway 106 checks the format of the mail body, presence/absence of an attachment, and presence/absence of the user information. It should be noted that the user information is the information acquired in Step 510 of FIG. 5.

Then, based on the determination result in Step 602, the mail gateway 106 determines whether or not the destination of the mail is in the own network, whether or not an image file is attached, and whether or not the settings of the user information are different (603). As a result, when the destination of the mail is in the own network, an image file is attached, and the settings of the user information are different, the image file needs to be converted, and hence the mail gateway 106 proceeds to Step 605. On the other hand, when the mail satisfies any one of the condition that the mail is sent to a mail transfer agent outside the network, the condition that an image file is not attached, and the condition that the settings of the user information are the same, the mail gateway 106 proceeds to Step 604, and determines whether or not the format of the mail is cHTML or not, namely whether or not the mail is a decoration mail.

As a result, when the mail format is cHTML, the mail body needs to be converted, and hence the mail gateway 106 proceeds to Step 605.

In Step 605, in order to separately provide and manage the mail body depending on the destination, the mail gateway 106 copies the mail body, separately provides the mail management information, attaches the separately provided mail management information to the copied mail body, and stores the mail management information and the mail body in the destination queue (605).

In the management method determination processing illustrated in FIG. 6, the mail gateway 106 determines whether or not the format of the mail is the cHTML, but the mail gateway 106 may determine whether or not the format of the mail is the plain text, and when the format of the mail is the plain text, the mail gateway 106 can determine that the conversion of the mail body is not necessary.

Further, the mail gateway 106 may determine whether or not the mail body includes a graphic symbol, and when the mail body includes a graphic symbol, the mail gateway 106 may determine that the mail body needs to be converted.

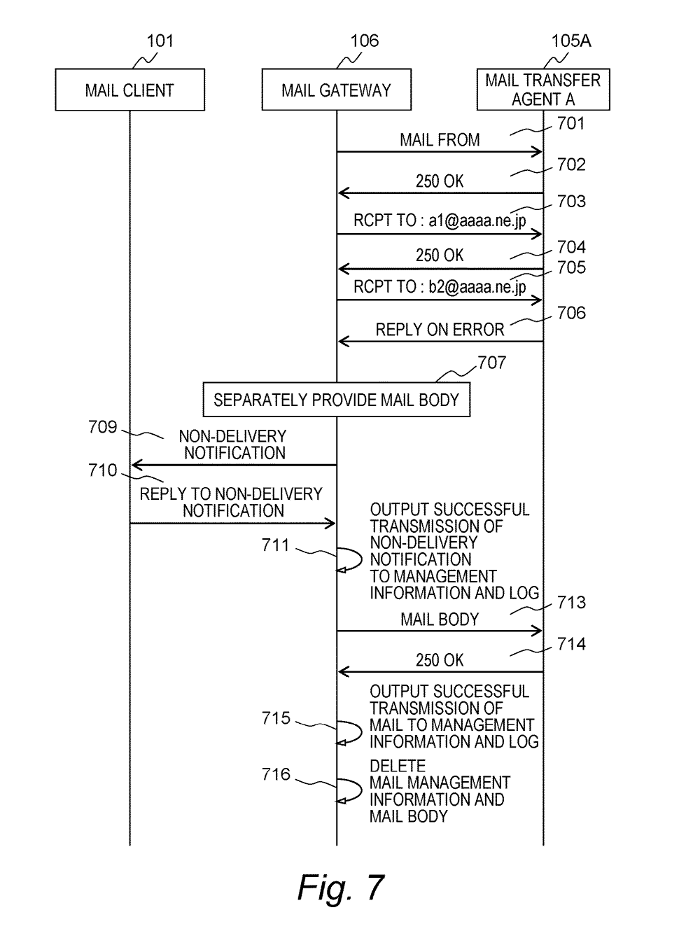

FIG. 7 is a sequence diagram in a case where delivery to a part of destinations of a mail for which data on a mail body is managed in common fails according to the first embodiment.

The mail transfer agent 105A is a mail server for accommodating destination addresses, but the mail transfer agent 105A may be a mail transfer agent on a transfer path to a mail server for accommodating the destination addresses.

First, the mail gateway 106 transmits, to the mail transfer agent A (105A), a MAIL FROM message, thereby notifying of a transmission source address of the mail (701). When the mail transfer agent A (105A) normally receives the MAIL FROM message, the mail transfer agent A (105A) transmits, to the mail gateway 106, a 250 OK message indicating that the MAIL FROM message is normally received (702).

Then, the mail gateway 106 transmits a RCPT TO message to the mail transfer agent A 105 (105A), thereby notifying the mail transfer agent A of one destination address (a1@aaaa.ne.jp) of the mail (703). The mail transfer agent A (105A) determines whether or not the destination address included in the RCPT TO message is accommodated in the mail transfer agent A (105A). When the destination address is accommodated in the mail transfer agent A (105A), the mail transfer agent A (105A) transmits a 250 OK message to the mail gateway 106 (704).

Further, the mail gateway 106 transmits a RCPT TO message to the mail transfer agent A 105 (105A), thereby notifying the mail transfer agent A of another destination address (b2@aaaa.ne.jp) of the mail (705). The mail transfer agent A (105A) determines whether or not the destination address included in the RCPT TO message is accommodated in the mail transfer agent A (105A). When the destination address is not accommodated in the mail transfer agent A (105A), the mail transfer agent A (105A) transmits an error reply to the mail gateway 106 (706).

When the mail gateway 106 receives the error reply, in order to transmit a non-delivery notification, the mail gateway 106 copies the mail body, thereby separately providing the mail bodies (707). The mail gateway 106 notifies the mail client 101 of the non-delivery of the mail sent to the address b2@aaaa.ne.jp (709). When the mail client 101 normally receives the non-delivery notification from the mail gateway 106, the mail client 101 transmits a reply to the non-delivery notification to the mail gateway 106 (710). When the mail gateway 106 receives the reply to the non-delivery notification, the mail gateway 106 outputs the transmission success of the notification that the mail sent to the address b2@aaaa.ne.jp is undelivered, namely the non-delivery notification, to the mail management information and the log (711). In place of Step 707, if the mail gateway 106 writes the failure of the transmission of the mail in Step 705 in the management and storage area for mail management information 205, the mail storage area 209 for backup, and the log, and generates a mail management information for storing only the non-delivery notification, the processing of Steps 707 to 711 can be carried out without the mail body being separately provided.

The mail gateway 106 transmits the mail body separately provided in Step 707, in parallel with Steps 709 and 710, as a mail addressed to the address a1@aaaa.ne.jp, to the mail transfer agent A (105A) (713). When the mail transfer agent A (105A) normally receives the mail body, the mail transfer agent A (105A) transmits, to the mail gateway 106, a 250 OK message indicating that the mail body is normally received (714).

When the mail gateway 106 receives the acknowledgement (250 OK) to the transmission of the mail body, the mail gateway 106 outputs the transmission success of the mail body to the mail management information and the log (715). As a result of the above-mentioned processing, the success of the transfer of the mail addressed to a1@aaaa.ne.jp and the failure (non-delivery) of the mail addressed to b2@aaaa.ne.jp are determined, and the mail gateway 106 thus deletes the mail management information and the mail data (body) from the management and storage area for mail management information 205 and the mail storage area 209 (716).

The mail gateway 106 processes the non-delivery notification to the mail client 101 (709 to 710) and the separate provision/transfer of the mail body (713 to 716) in independent threads in parallel, but if the mail gateway 106 sequentially processes the non-delivery notification to the mail client 101 (709 to 710) and the separate provision/transfer of the mail body (713 to 716), the mail client can carry out the processing in one thread.

In the sequence illustrated in FIG. 7, by sequentially outputting the results of the transfer to the mail management information and the log, the state of the mail can be managed in a simplified manner. For example, when the transfer of the mail is successful, by the output to the log, the delivery processing can be brought into the finished state.

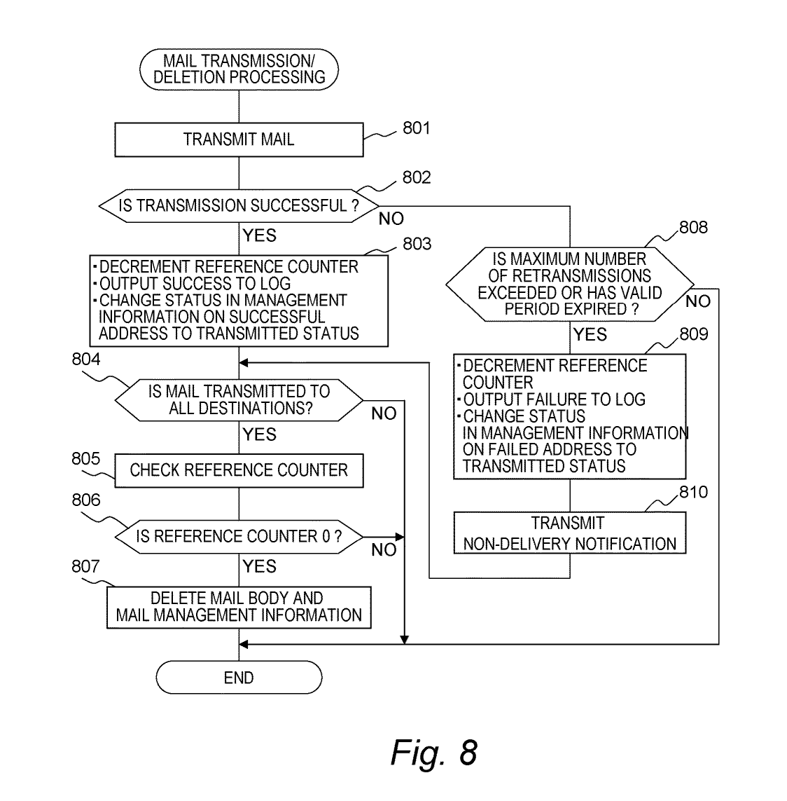

FIG. 8 is a flowchart for the mail transmission/deletion processing according to the first embodiment, and is carried out in Steps 415 to 421 of FIG. 4 by the mail gateway 106 (mail gateway program 204).

The mail gateway 106 transmits the mail body to the mail transfer agent (or a next mail transfer agent) (801), and waits for a reply from the mail transfer agent of the transfer destination. The mail gateway 106 determines the reply from the mail transfer agent of the transfer destination (802). When the reply from the mail transfer agent of the transfer destination is a transmission success, the mail gateway 106 proceeds to Step 803, and starts the processing of deleting the mail data. On the other hand, when the reply from the mail transfer agent of the transfer destination is a transmission failure, the mail gateway 106 proceeds to Step 808, and transmits a non-delivery notification.

In Step 803, the transmission of the mail is successful, and the mail gateway 106 thus decrements a reference number (reference counter) of the mail data by one, outputs the success of the mail transmission to the log, and changes the state of the management information on an address to which the mail transmission is successful to a transmitted state.

Then, the mail gateway 106 determines, by referring to the states included in the mail management information, whether or not the transmissions of the mail to all the destinations are completed (804). It should be noted that, to the reference counter, the number of pieces of the mail management information on the mail is set.

As a result of the determination, when the transmission of the mail to a part of destinations is not completed, in order to transmit the mail to other destinations, the mail gateway 106 finishes the mail transmission/deletion processing, and starts the transmission/deletion processing for a next destination. On the other hand, when the transmission of the mail to all the destinations has been completed, the mail gateway 106 checks the reference counter indicating the number of pieces of mail management information on the mail which are linked to the mail body and which have the addresses to which the mail has not been transmitted (805). As a result, when the number of the reference counter is 0 (YES in Step 806), the transmission of the mail to all the destinations has been completed, and hence the mail gateway 106 deletes the mail body and the mail management information (807), and finishes the mail transmission/deletion processing. On the other hand, when the reference number for the mail data is not 0 (NO in Step 806), the mail has not been transmitted to a part of the destinations, and, and hence in order to transmit the mail to the addresses to which the mail has not been transmitted, the mail gateway 106 finishes the mail transmission/deletion processing, and starts the transmission/deletion processing for a next destination.

On the other hand, the mail transmission has failed in Step 808, and hence the mail gateway 106 determines whether or not the number of retransmissions of this mail exceeds a maximum number of retransmissions and whether or not a valid period has been expired (808). When the number of retransmissions of this mail does not exceed the maximum number of retransmissions and the valid period has not been expired, in order to retransmit the mail, the mail gateway 106 finishes the mail transmission/deletion processing, and starts the next mail transmission/deletion processing.

On the other hand, when the maximum number of retransmissions has been exceeded, or when the valid period has been expired, the mail does not need to be retransmitted to the address, and the transmission of the mail to the destination is processed as an error. Accordingly, the mail gateway 106 decrements the reference counter by 1, outputs the failure of the mail transmission to the log, and changes the state included in the mail management information on the address to which the mail transmission has failed to the transmitted state (809). Then, the mail gateway 106 transmits a non-delivery notification (810) and proceeds to Step 804. In other words, when the mail client 101 receives the non-delivery notification, the mail is treated as a transmitted mail.

As described above, according to the first embodiment of this invention, the management method for the mail is determined depending on the mail management information and the mail body, and proper mail management is provided depending on the mail. Therefore, the storage area required for storing the mails can thus be reduced, and the efficiency of the relay processing for the mail can be improved.

Moreover, in the mail management information, the mail management method is primarily determined, and then, depending on the mail body, the mail management method is finally determined. Therefore, the management method for the mail can thus be efficiently determined.

### Second Embodiment

A description is now given of a second embodiment of this invention. The second embodiment is different from the above-mentioned first embodiment in that the mail gateway 106 does not include the mail storage area but a data store server 108 includes the mail storage area. In other words, the data on a mail to be transferred by the mail gateway 106 is transferred from the mail gateway 106 to the data store server 108, and is deleted after the transfer of the mail is completed by the mail gateway 106.

In the second embodiment, the same functional components and processing as those described above in the first embodiment are assigned the same reference symbols as in the first embodiment and the descriptions thereof are omitted.

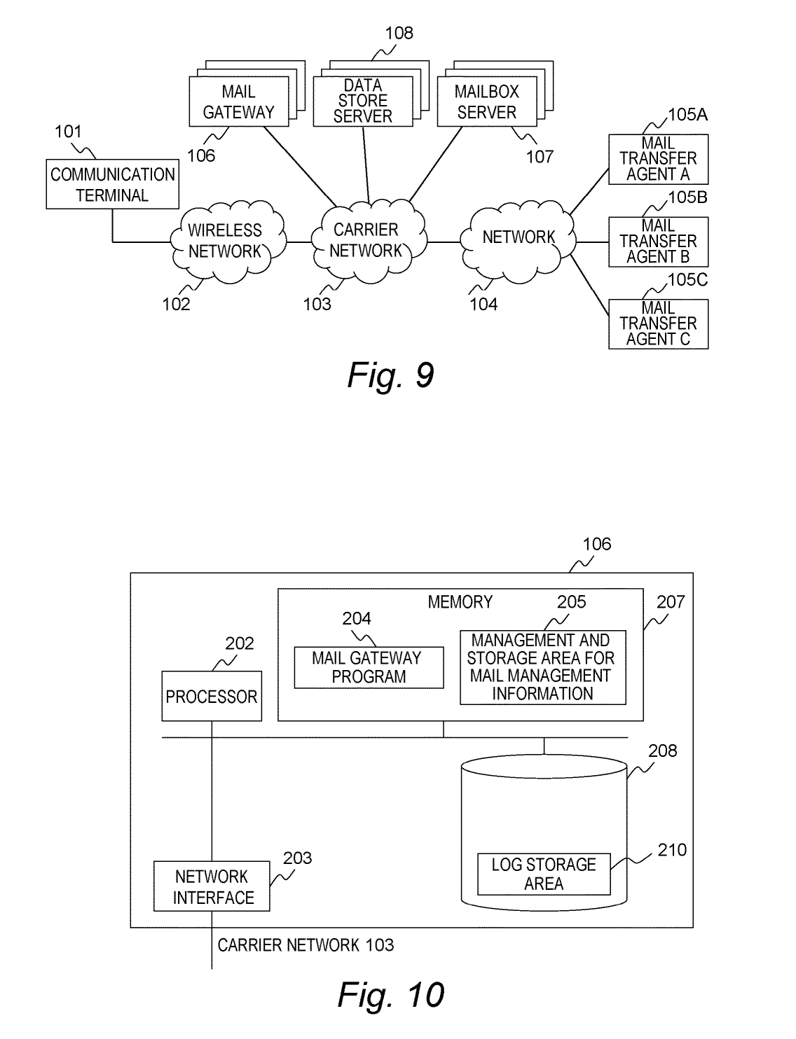

FIG. 9 is a block diagram illustrating a configuration of a mail transfer system according to a second embodiment.

The mail transfer system according to the second embodiment is constituted in a carrier network 103, and includes a mail gateway 106, a mailbox server 107, and a data store server 108. The mail gateway 106, the mailbox server 107, and the data store server 108 are coupled to one another by the carrier network 103.

The carrier network 103 is connected via a wireless network 102 to a communication terminal 101, and is connected via a network 104 to mail transfer agents 105A to 105C.

The mail gateway 106 is a computer for receiving mail data transmitted from the communication terminal 101, and transferring the received mail data to the mail transfer agent 105A or the like. In a storage device 208 of the mail gateway 106, a log storage area 210 is provided. The mail storage area 209 provided in the mail gateway 106 according to the first embodiment is provided in the data store server 108.

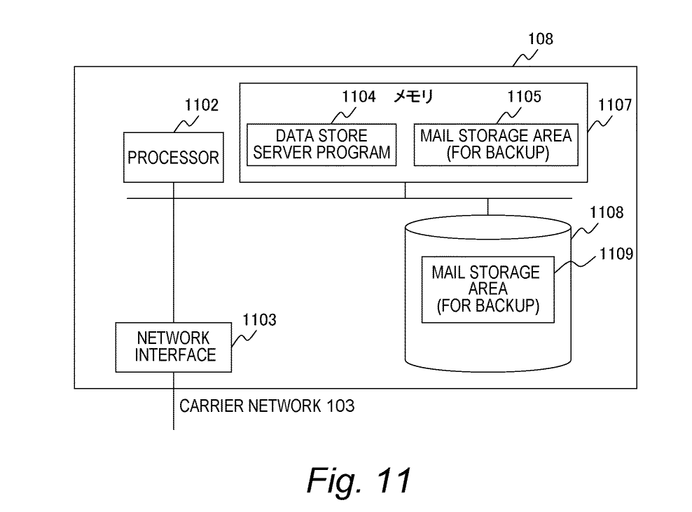

The data store server 108 includes a mail storage area (1009 of FIG. 11) for temporarily storing the mail data which is transmitted by the communication terminal 101 and which is transferred to each of the mail transfer agent 105A and the like.

FIG. 10 is a block diagram illustrating a configuration of the mail gateway 106 according to the second embodiment.

The mail gateway 106 includes a processor 202, a memory 207, a network interface 203, and the storage device 208.

The storage device 208 is a non-volatile storage device such as a magnetic disk device or a flash memory, and is provided with a management information storage area 211 and a log storage area 210. In a management and storage area for mail management information 205, mail bodies and mail management information of received mails (mails to be transferred) are stored. The mail management information stored in the management and storage area for mail management information 205 is deleted after a mail has been transferred to a transfer destination server.

The second embodiment is different from the first embodiment in that the mail storage area for backup is not held in the nonvolatile storage device 208, but instead, the backup is stored in the data store server 108.

FIG. 11 is a block diagram illustrating a configuration of the data store server 108 according to the second embodiment.

The data store server 108 includes a processor 1102, a memory 1107, a network interface 1103, and a storage device 1108.

The processor 1102 executes a data store server program 1104. By the processor 1102 executing the data store server program 1104, various pieces of processing carried out by the data store server 108 are realized.

The network interface 1103 is connected to the carrier network 103, and carries out communication to/from the mail gateway 106 depending on a predetermined protocol. The storage device 1108 is a nonvolatile storage device such as a magnetic disk device or a flash memory. The data store server program 1104 manages the mail storage area 1105 for backup and a mail storage area 1109 for backup which are storage areas for back up for the management and storage area for mail management information 205 of the mail gateway 106. According to this embodiment, the data store server program 1104 holds the mail storage area 1105 for backup and the mail storage area 1109 for backup, but even if the data store server program 1104 holds only any one of the mail storage areas 1105 for backup and 1109, this invention can be embodied. According to this embodiment, the data store server holds data, as in a cache, in the mail storage area 1105 for backup, and holds data, as in a main memory device, in the mail storage area 1109 for backup.

The mail storage area 1105 for backup and the mail storage area 1109 for backup store only mails according to this embodiment, but the data store server can store data other than mails, and can uniformly treat the stored data as binary data.

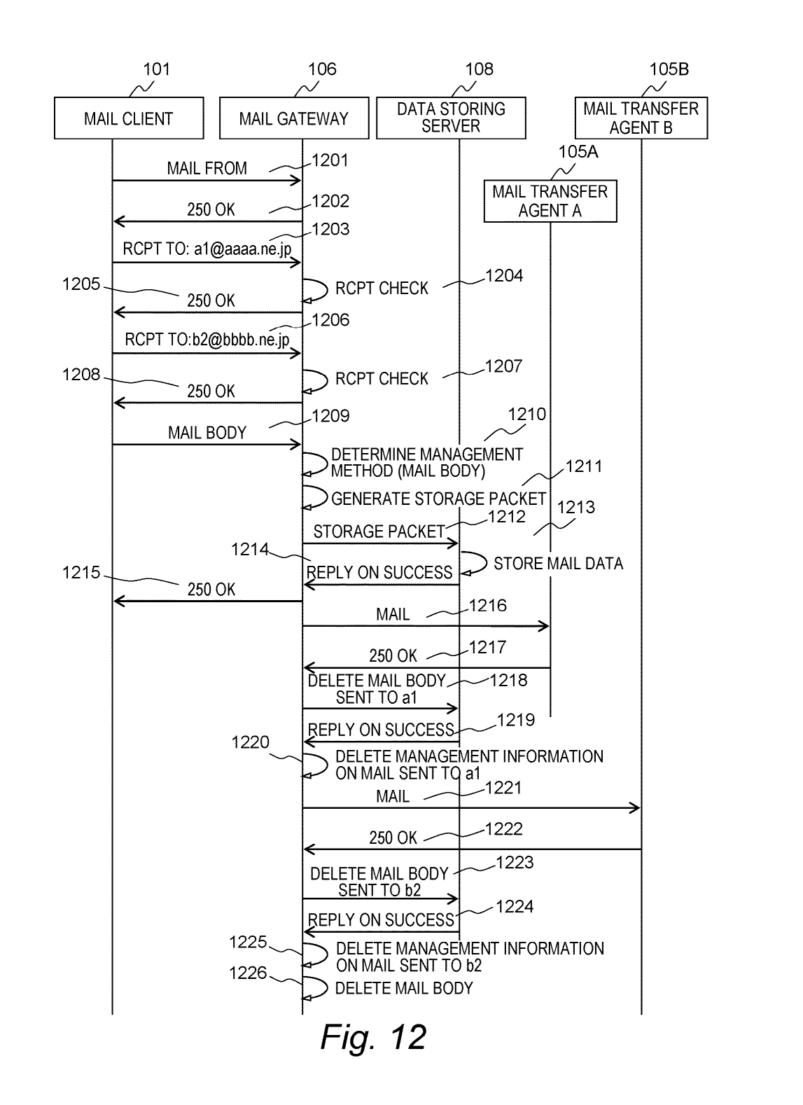

FIG. 12 illustrates an example (a case where mail data is shared) of a sequence of mail transfer processing according to the second embodiment.

When the communication terminal (mail client) 101 transmits a mail, the communication terminal 101 establishes a connection to the mail gateway, and then transmits to the mail gateway 106 a MAIL FROM message 1201, thereby notifying of an address of the transmission source of the mail. In a parameter of the MAIL FROM message 1201, the address of the transmission source of the mail is described. When the mail gateway 106 normally receives the MAIL FROM message, the mail gateway 106 transmits, to the mail client 101, a 250 OK message 1202 indicating that the MAIL FROM message is normally received.

Then, the mail client 101 transmits a RCPT TO message 1203 to the mail gateway 106, thereby notifying of one destination address (a1@aaaa.ne.jp) of the mail. In a parameter of the RCPT TO message, the destination address is described. The mail gateway 106 determines whether or not the destination address included in the received RCPT TO message is correct, and primarily determines a method of storing the mail in the data store server 108 (mail storage area 1109) (1204). Then, when the mail gateway 106 determines that the destination address is correct, the mail gateway 106 transmits a 250 OK message 1205 to the mail client 101. For the RCPT check in Step 1204, the above-mentioned method according to the first embodiment (FIG. 5) can be used.

Then, when the mail includes a plurality of destinations, the mail client 101 transmits a RCPT TO message 1206 to the mail gateway 106, thereby notifying of another destination address (b2@bbbb.ne.jp) of the mail. The mail gateway 106 determines whether or not the destination address included in the received RCPT TO message is correct, and primarily determines a method of storing the mail in the data store server 108 (1207). Then, when the mail gateway 106 determines that the destination address is correct, the mail gateway 106 transmits a 250 OK message 1208 to the mail client 101. For the RCPT check in Step 1207, the above-mentioned method according to the first embodiment (FIG. 5) can be used.

When the mail client 101 has transmitted all RCPT TO messages (destination addresses), the mail client 101 transmits a mail body 1209.

When the mail gateway 106 normally receives a mail (management information such as a transmission source and a destination, and a body), the mail gateway 106 stores the mail in the management and storage area for mail management information 205, determines the management method for the mail body (1210), and based on the determined management method, generates a storing packet in the data store server 108 (1211) to thereby transfer the generated storing packet to the data store server 108 (1212).

The data store server 108 stores the received storing packet in the mail storage area 1105 and the mail storage area 1109 (1213), and transmits an acknowledgement indicating the completion of the storage of the received packet to the mail gateway 106 (1214).

When the mail gateway 106 receives the acknowledgement from the data store server 108, the mail gateway 106 transmits a 250 OK message 1215 indicating that the mail is normally received to the mail client 101 (1215).

Then, the mail gateway 106 transfers the mail to the mail transfer agent A (105A) accommodating the destinational (1216). When the mail transfer agent A (105A) normally receives the mail, the mail transfer agent A (105A) transmits, to the mail gateway 106, a 250 OK message 1217 indicating that the mail is normally received (1217). When the mail gateway 106 succeeds in the transfer of the mail addressed to the destinational, the mail gateway 106 transmits a request to delete the mail addressed to the destinational to the data store server 108 (1218). When the data store server 108 receives the request to delete the mail addressed to the destinational, the data store server 108 deletes the mail addressed to the destinational from the mail storage area 1105 and the mail storage area 1109. When the mail gateway 106 receives a success reply 1219 on the deletion from the data store server, the mail gateway 106 deletes the management information on the mail addressed to the destinational from the management and storage area for mail management information 205 (1220).

Then, the mail gateway 106 transfers the mail to the mail transfer agent B (105B) accommodating the destination b2 (1221). When the mail transfer agent B (105B) normally receives the mail, the mail transfer agent B (105B) transmits, to the mail gateway 106, a 250 OK message 1222 indicating that the mail is normally received (1222). When the mail gateway 106 succeeds in the transfer of the mail addressed to the destination b2, the mail gateway 106 transmits a request to delete the mail addressed to the destination b2 to the data store server 108 (1223). When the data store server 108 receives the request to delete the mail addressed to the destination b2, the mail gateway 106 deletes the mail addressed to the destination b2 from the mail storage area 1105 and the mail storage area 1109 and transmits a success reply 1224 on the deletion from the data store server. When the mail gateway 106 receives the success reply 1224, the mail gateway 106 deletes the management information on the mail addressed to the destination b2 from the management and storage area for mail management information 205 (1225), and deletes the data on the mail body managed commonly for the mail addressed to the destination a 1 and the mail addressed to the destination b2 from the queue (1226).

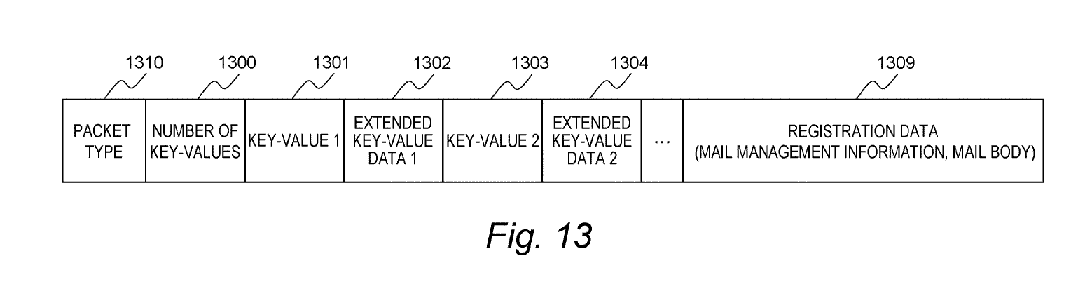

FIG. 13 is a diagram illustrating an example of a packet transmitted to the data store server 108 according to the second embodiment.

The packet transmitted to the data store server 108 includes a packet type 1310, the number of key-values 1300, a plurality of key-values 1301 and 1303, a plurality of pieces of extended key-value data 1302 and 1304, and registration data 1309.

The packet type 1310 indicates processing (such as registration or deletion) carried out by the data store server 108 which has received the packet.

The number of key-values 1300 indicates the number of key-values included in the packet. The two key-values are illustrated in FIG. 13, but the number of key-values may be one or any plural number. The key-values 1301 and 1303 are identifiers for uniquely identifying mail management information corresponding to a key-value. The extended key-value data 1302 and 1304 each store data on a difference between the mail management information corresponding to the key-value and basic mail management information. It should be noted that, as the basic mail management information, it is preferred that initial mail management information be used. The registration data 1309 includes the mail management information and the mail body.

Also in the second embodiment, the mail gateway 106 manages a mail by means of any one of the mail management methods 1 to 3.

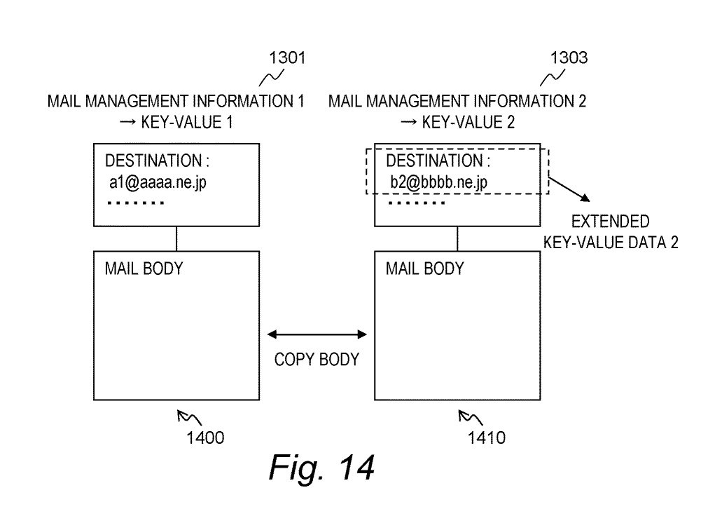

FIG. 14 is a diagram illustrating the mail management performed by the mail gateway 106 according to the second embodiment, and illustrates the case of the completely separated method (FIG. 3A).

First, mail data (mail management information and mail body) is generated for each destination. Then, to an original mail 1400 and a mail 1411 newly generated by copying, key-values 1301 and 1303 are respectively assigned.

Then, the mail gateway 106 compares the mail management information of the each mail and the mail management information of the first mail, thereby storing a difference in extended key-value data 2 (1304). The mail management information corresponding to the extended key-value data 1 (1302) does not include a difference, and information indicating that there is no difference in the extended key-value data 1 (1302) is thus stored.

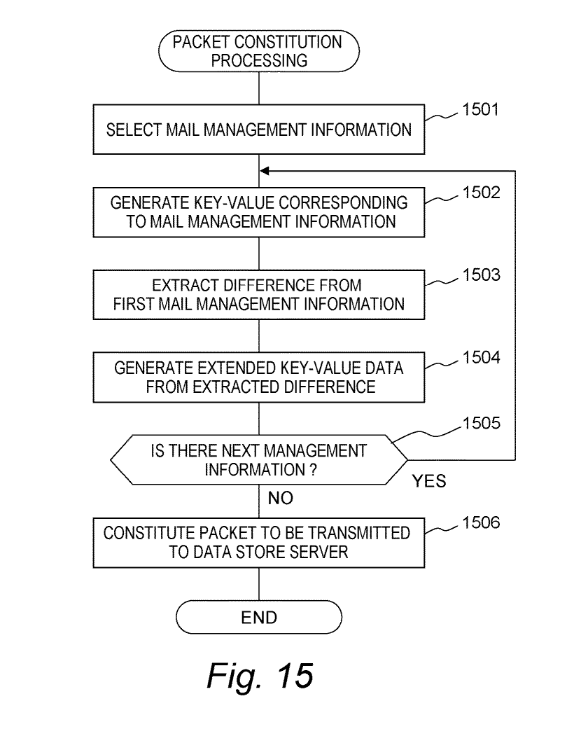

FIG. 15 is a flowchart of packet configuration processing performed by the mail gateway 106 according to the second embodiment.

First, the mail gateway 106 selects the mail management information on a second mail (1501), and generates a key-value corresponding to the selected mail management information (1502).

Then, the mail gateway 106 extracts a difference of the selected mail management information from the first mail management information (1503), and stores the extracted difference to the extended key-value data on a corresponding key-value, thereby generating storage key-value data (1504).

Then, the mail gateway 106 determines whether or not there is next mail management information (1505). When there is next mail management information, the mail gateway 106 returns to Step 1502, and processes a next mail. When there is not next mail management information, on the other hand, the processing has finished for all pieces of mail management information, and hence the mail gateway 106 concatenates the generated pieces of extended key-value data to each other, thereby constituting a packet to be transmitted to the data store server 108 (1506).

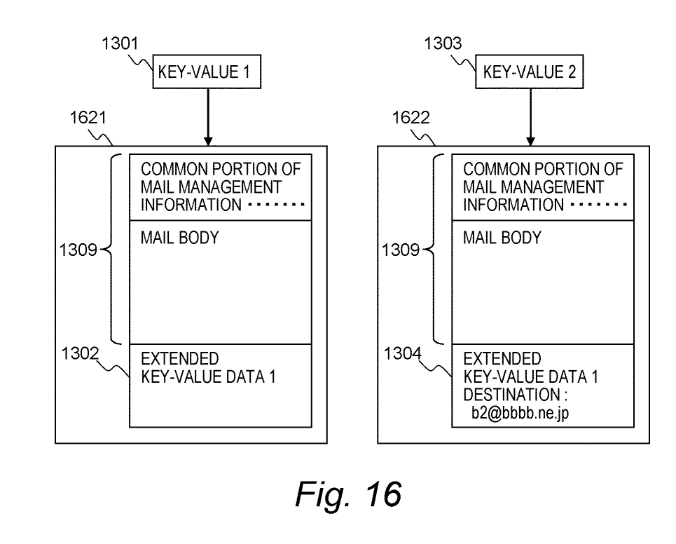

FIG. 16 is a diagram illustrating the storage of data in the data store server 108 according to the second embodiment.

First, the data store server 108 allocates storage areas 1621 and 1622 for respective key-values in the mail storage area 1109, and stores the registration data 1309 in the allocated storage areas. Then, the data store server 108 stores the extended key-value data 1302 and 1304 corresponding to the respective key-values to the subsequent portions in the storage areas 1621 and 1622.

The above-mentioned data store server 108 separately provides and stores mail data for each destination. This is because, generally, the data store server 108 has a sufficient storage capacity, and can carry out high-speed processing, and, also, the data store server 108 does not recognize the data transmitted from the mail gateway 106 as a mail, and simply treats mails, texts, and images in the same manner. However, when the data store server 108 stores mail data, mail data can be reconstructed for each destination, and common portions can be grouped together.

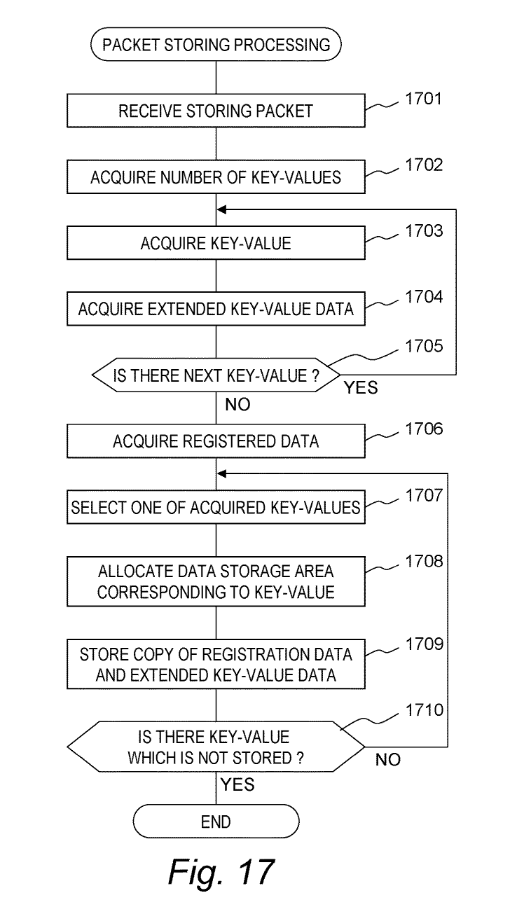

FIG. 17 is a flowchart of packet storing processing performed by the data store server 108 according to the second embodiment.

When the data store server 108 receives a packet from the mail gateway 106, the data store server 108 determines the packet type 1310 of the received packet. When the packet type 1310 of the received packet is “REGISTRATION”, the data store server 108 determines that a storing packet is received, and starts the packet storing processing (1701).

First, the data store server 108 acquires the number of key-values included in the packet which is the received storing packet to determine a loop count (1702). Then, the data store server 108 acquires key-values and extended key-value data from the received packet (1703 and 1704), and, until there is no next key-value (until the acquired number of key-values reaches the number of key-values acquired in Step 1702), repeats the processing of Steps 1703 and 1704 (1705). Then, the data store server 108 acquires the registration data (mail management information and mail body) from the received storing packet (1706).

Then, the data store server 108 selects one key-value being the first key-value out of the acquired key-values (1707), and allocates a data storage area corresponding to the selected key-value (1708). Then, the data store server 108 stores the registration data and extended key-value data which are acquired in the step 1706 in the data storage area (1709). Then, the data store server 108 repeats the processing of Steps 1707 to 1709 until the processing is completed for all the key-values.

As described above, according to the second embodiment of this invention, even if the data store server 108 is provided independently of the mail gateway 106, a proper mail management method can be selected, the storage capacity required for storing mails can be reduced, and the efficiency of the mail relay processing can be improved.

Moreover, the mail gateway 106 transmits, instead of transmitting entire mail data (main body and mail management information) and the respective pieces of mail management information, the differences of the respective pieces of mail management information of the base mail data to the data store server 108, and the increase in data amount transmitted from the mail gateway 106 to the data store server 108 can be suppressed.

Further, the data store server 108 stores the mail data received from the mail gateway 106 in the mail storage area 1109 without reconstructing the mail data, and the data store server 108 can increase the speed of the processing of mails.

While the present invention has been described in detail and pictorially in the accompanying drawings, the present invention is not limited to such detail but covers various obvious modifications and equivalent arrangements, which fall within the purview of the appended claims.

What is claimed is:

1. A mail transfer system, comprising:
a mail gateway for receiving an electronic mail transmitted from a terminal;
a network for coupling the terminal and the mail gateway to each other; and
a data storage area for temporarily storing the received electronic mail,
the mail gateway being coupled to a plurality of mail transfer servers,
the mail gateway including a queue for storing a mail to be transferred for each of the plurality of mail transfer servers which are transfer destinations of the mail,
the mail gateway being configured to:
in a case where destinations of the received electronic mail include a plurality of destinations accommodated in the same mail transfer server, generate a piece of first mail management information including the plurality of destinations accommodated in the same mail transfer server, and store mail data linking the generated piece of first mail management information and a body of the electronic mail to each other in the data storage area; and
in a case where the destinations of the received electronic mail include one destination accommodated in the same mail transfer server, generate mail management information for each of the destinations, which includes the each of the destinations, and store mail data linking each of a plurality of pieces of the generated mail management information and a body of the electronic mail in the data storage area.

2. The mail transfer system according to claim 1,
wherein the mail gateway is further configured to:
generate a piece of first mail management information including the plurality of destinations accommodated in a first mail transfer server and a piece of second mail management information including the one destination accommodated in a second mail transfer server in a case where the destinations of the received electronic mail include a plurality of destinations accommodated in the first mail transfer server and one destination accommodated in the second mail transfer server; and
store mail data liking the generated piece of first mail management information and the generated piece of second mail management information and a body of the electronic mail to each other in the data storage area.

3. The mail transfer system according to claim 1, wherein the mail gateway is further configured to:
add the destinations to mail management information storing the plurality of destinations accommodated in the same mail transfer server in a case where the destinations of the received electronic mail include the plurality of destinations accommodated in the same mail transfer server, and a number of the plurality of destinations accommodated in the same mail transfer server does not exceed a maximum value thereof; and
newly generate mail management information corresponding to the one destination in a case where the destinations of the received electronic mail include one destination accommodated in each of the plurality of mail transfer servers, or a number of destinations accommodated in the each of the plurality of mail transfer servers exceeds a maximum value thereof.

4. The mail transfer system according to claim 1, wherein the mail gateway is further configured to:
determine whether or not data on the body of the received electronic mail needs to be modified before transferring the received electronic mail to the mail transfer server;
copy the body of the received electronic mail for each of pieces of the mail management information in a case where it is determined that the data on the body of the received mail needs to be modified; and
store mail data liking the each of the plurality of pieces of the mail management information and each of the copied bodies of the electronic mail to each other in the data storage area.

5. The mail transfer system according to claim 4, wherein the mail gateway is further configured to:
determine that the data on the body of the received electronic mail needs to be modified in a case where the received electronic mail is addressed to a mail transfer server in a network which includes the mail gateway, an image file is attached, and settings for an attached file for respective destinations are different; and
determine that the data on the body of the electronic mail needs to be modified in a case where the received electronic mail is in a cHTML format.

6. The mail transfer system according to claim 1, further comprising a data store server including the data storage area,
wherein the mail gateway is further configured to:
generate mail data by dividing the received electronic mail into a difference in the mail management information for each of the destinations of the electronic mail, and a base portion including the body of the electronic mail and the mail management information; and
transmit the generated mail data to the data store server.

7. The mail transfer system according to claim 6, wherein the data store server stores the received mail data in the data storage area without rebuilding the mail data for each of the destinations of the electronic mail in a case where the data store server receives the mail data from the mail gateway.

8. A mail gateway to be coupled to a terminal via a network, for receiving an electronic mail transmitted from the terminal,
the mail gateway being coupled to a plurality of mail transfer servers, and a data storage area for temporarily storing the received electronic mail,
the mail gateway including a queue for storing a mail to be transferred for each of the plurality of mail transfer servers which are transfer destinations of the mail,
the mail gateway being configured to:
in a case where destinations of the received electronic mail include a plurality of destinations accommodated in the same mail transfer server, generate a piece of first mail management information including the plurality of destinations accommodated in the same mail transfer server, and store mail data linking the generated piece of first mail management information and a body of the electronic mail to each other in the data storage area; and
in a case where the destinations of the received electronic mail include one destination accommodated in the same mail transfer server, generate mail management information for each of the destinations, which includes the each of the destinations, and store mail data linking each of a plurality of pieces of the generated mail management information and a body of the electronic mail in the data storage area.

9. The mail gateway according to claim 8, wherein the mail gateway is further configured to:
generate a piece of first mail management information including the plurality of destinations accommodated in a first mail transfer server and a piece of second mail management information including the one destination accommodated in a second mail transfer server in a case where the destinations of the received electronic mail include a plurality of destinations accommodated in a first mail transfer server and one destination accommodated in a second mail transfer server; and
store mail data liking the generated piece of first mail management information and the generated piece of second mail management information and a body of the electronic mail to each other in the data storage area.

10. The mail gateway according to claim 8, wherein the mail gateway is further configured to:
add the destinations to mail management information storing the plurality of destinations accommodated in the same mail transfer server in a case where the destinations of the received electronic mail include the plurality of destinations accommodated in the same mail transfer server, and a number of the plurality of destinations accommodated in the same mail transfer server does not exceed a maximum value thereof; and
when the destinations of the received electronic mail include one destination accommodated in each of the plurality of mail transfer servers, or a number of destinations accommodated in the each of the plurality of mail transfer servers exceeds a maximum value thereof, newly generate mail management information corresponding to the one destination in a case where the destinations of the received electronic mail include one destination accommodated in each of the plurality of mail transfer servers, or a number of destinations accommodated in the each of the plurality of mail transfer servers exceeds a maximum value thereof.

11. The mail gateway according to claim 8, wherein the mail gateway is further configured to:
determine whether or not data on the body of the received electronic mail needs to be modified before transferring the received electronic mail to the mail transfer server;
copy the body of the received electronic mail for each of pieces of the mail management information in a case where it is determined that the data on the body of the received mail needs to be modified; and
store mail data liking the each of the plurality of pieces of the mail management information and each of the copied bodies of the electronic mail to each other in the data storage area.

12. The mail gateway according to claim 11, wherein the mail gateway is further configured to:
determine that the data on the body of the received electronic mail needs to be modified in a case where the received electronic mail is addressed to a mail transfer server in a network which includes the mail gateway, an image file is attached, and settings for an attachment for respective destinations are different; and
further determine that the data on the body of the electronic mail needs to be modified in a case where the received electronic mail is in a cHTML format.

13. The mail gateway according to claim 8,
wherein the mail gateway is connected to a data store server including the data storage area, and
wherein the mail gateway is further configured to:
generate mail data by dividing the received electronic mail into a difference in the mail management information for each of the destinations of the electronic mail, and a base portion including the body of the electronic mail and the mail management information; and
transmit the generated mail data to the data store server.

14. A data store server comprising a data storage area for temporarily storing an electronic mail transmitted from a terminal and received by a mail gateway,
in a case where the mail gateway transfers the received electronic mail to a plurality of destinations, the mail gateway generating mail data by dividing the received electronic mail into a difference in the mail management information for each of the destinations of the electronic mail and a base portion including a body of the received electronic mail and mail management information, and transmitting the generated mail data to the,
the data store server storing the received mail data in the data storage area without rebuilding the mail data for the each of the destinations of the electronic mail in a case where the data store server receives the mail data from the mail gateway.
